(19) United States
(12) Patent Application Publication
(10) Pub. No.: US 2006/0234555 A1
(43) Pub. Date: Oct. 19, 2006

(54) Electrical connector with shielding shell

(75) Inventor: Yung-Chien Chung, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/406,912

(22) Filed: Apr. 19, 2006

(30) Foreign Application Priority Data
Apr. 19, 2005 (CN) 200520070983.2

(51) Int. Cl. H01R 13/648

(52) U.S. Cl. 439/607

(57) ABSTRACT

An electrical connector (100) includes an insulative housing (1) and a shielding shell (2) and a plurality of terminal (3) disposed on the housing. The insulating housing includes a base portion (10) and a tongue portion (11) projecting from the base portion. The shielding shell includes a front portion (21) surrounding the tongue portion and defining a pair of opposite walls, back portion (22) surrounding the base portion and defining a pair of corresponding opposite walls, and a pair of connecting portion (23) unitarily connecting the front and back portion at the opposite walls thereof.

### BACKGROUND OF THE INVENTION

1. Field of the Invention

The present invention generally relates to an electrical connector, and more particularly relates to an electrical connector with a shielding shell having a front and a back portion connected with each other.

2. Description of Related Arts

Electrical connection between a system and peripherals is established through a receptacle connector and a plug connector. Generally, the receptacle with recessed space is equipped in the system and the plug with protruding front mating portion is equipped in the peripheral, such as a cable end. Said receptacle and plug are often damaged because of mis-mating or aging. For easily replacement, the plug on cable end is hoped to be damaged firstly, not the receptacle, because the plug is easy to replace.

Taiwan Patent Number M240704 discloses an electrical connector assembly with a receptacle and a plug. Referring to FIGS. 5˜6, the unitary shell of the plug includes a front portion surrounding the front mating portion and a back portion surrounding the back base portion. The middle portion joining the front and back portions together has a top wall and two opposite sidewalls, which make the shell has strong torsion force. Even in FIG. 3, the shell of the plug has a connecting portion with only top wall extending transversely, which also has strong torsion force. Obviously, it cannot ensure that the connecting portions of said two shells rupture firstly and thus the receptacle connecter might be damaged.

Hence, an improved electrical connector is required to overcome the aforesaid disadvantages of the prior art.

### SUMMARY OF THE INVENTION

It is an object of the present invention to provide an electrical connecter with a shielding shell, which can be predefined with appropriate torsion force.

In order to achieve the above-mentioned object, an electrical connector includes an insulative housing, a shielding shell and a plurality of terminals disposed on the housing. The insulating housing includes a base portion and a tongue portion projecting from the base portion. The shielding shell includes a front portion surrounding the tongue portion and defining a pair of opposite walls, back portion surrounding the base portion and defining a pair of corresponding opposite walls, and a pair of connecting portion unitarily connecting the front and back portion at the opposite walls thereof.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector in accordance with the present invention;

FIG. 2 is an exploded view of the electrical connector shown in FIG. 1;

FIG. 3 is a perspective view of the electrical connector in FIG 1 from another direction;

FIG. 4 is an exploded view of the electrical connector shown in FIG. 3; and

FIG. 5 is an exploded view of locking pieces of the electrical connecter.

### DETAILED DESCRIPTION OF THE PREFERRED EMBODIMENT

Reference will now be made to the drawing figures to describe the present invention in detail.

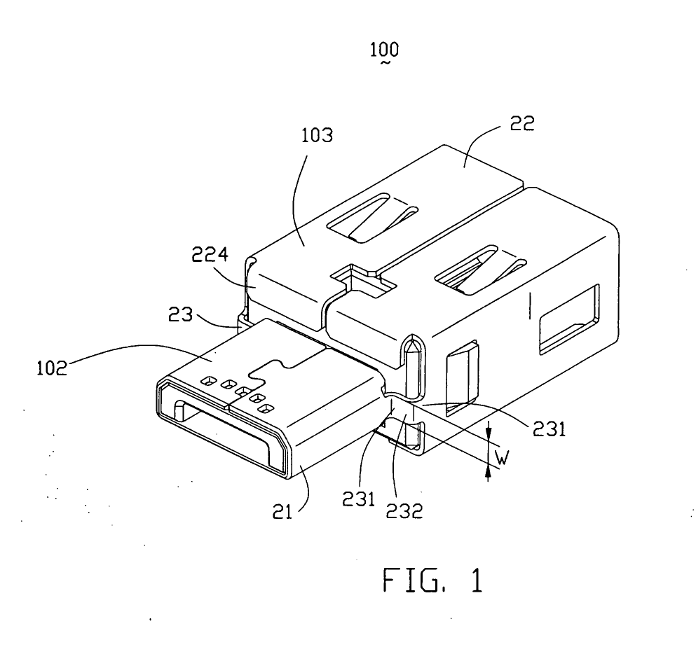

As shown in FIG. 1, an electrical connector 100 in accordance with the present invention has a front-mating section 102 mating with a complement connector (not shown) and a back-connecting section 103 which is larger than the front-mating section 102 and connects with a cable (not shown).

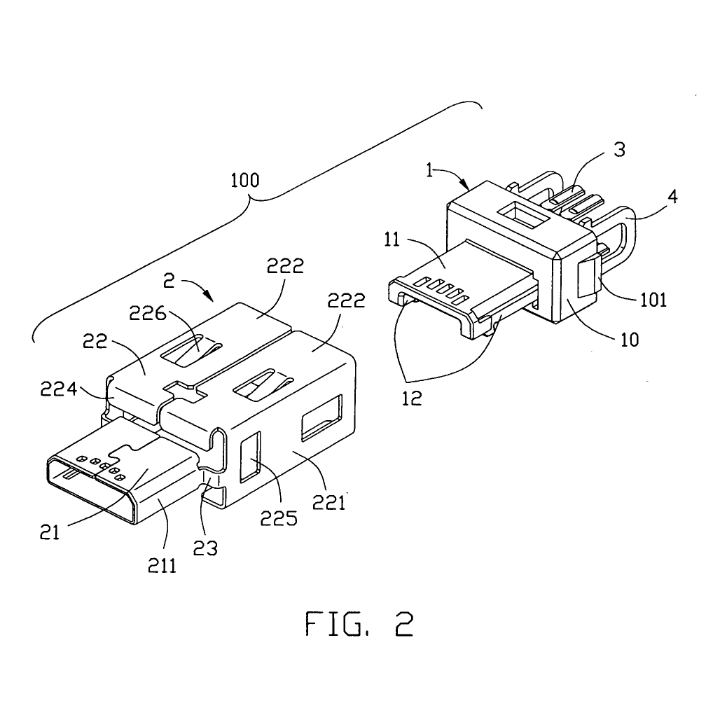

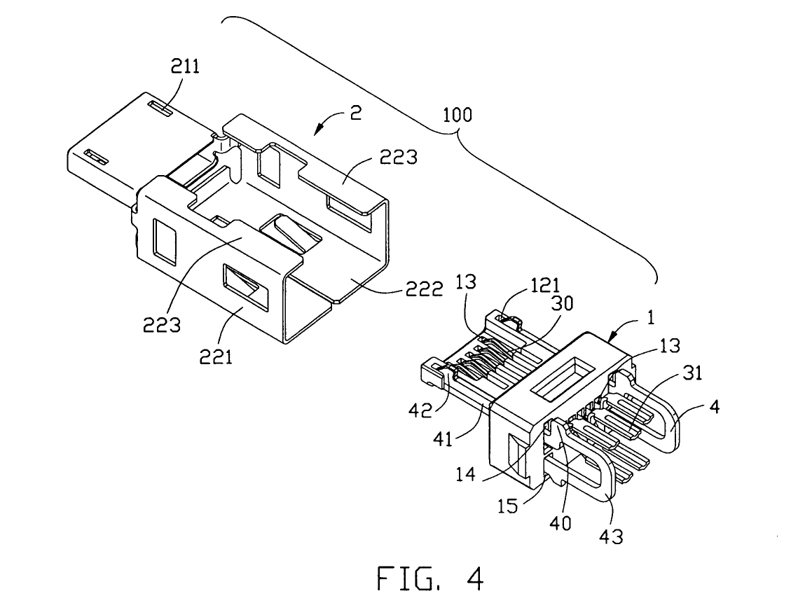

Referring to FIG. 2, the electrical connector 100 includes an insulative housing 1, a shielding shell 2, a plurality of terminals 3 and a pair of locking pieces 4 received in the insulative housing. The insulative housing 1 includes a base portion 10 and a tongue portion 11 projecting forwards from the base portion 10. The tongue portion defines a pair of edge portions 12 respectively extending downwards from two opposite side fringes thereof and a pair of cutouts 121 in the front ends of the edge portions 12 respectively, as shown in FIG. 4.

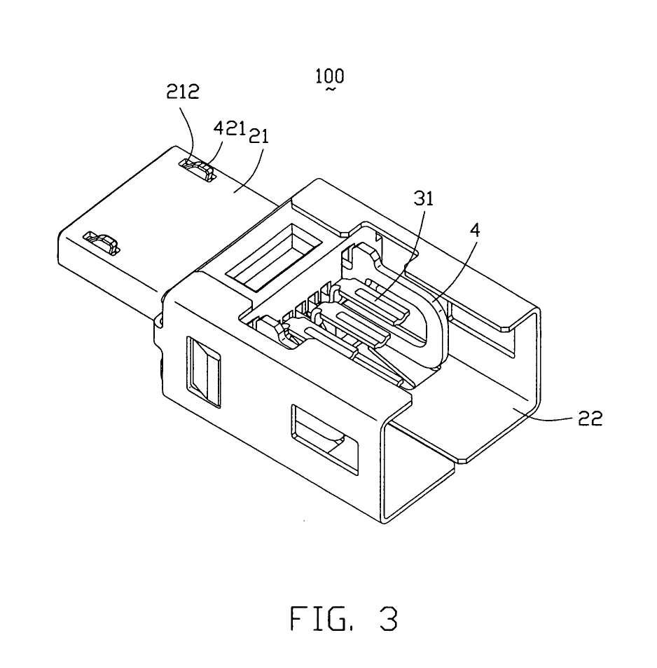

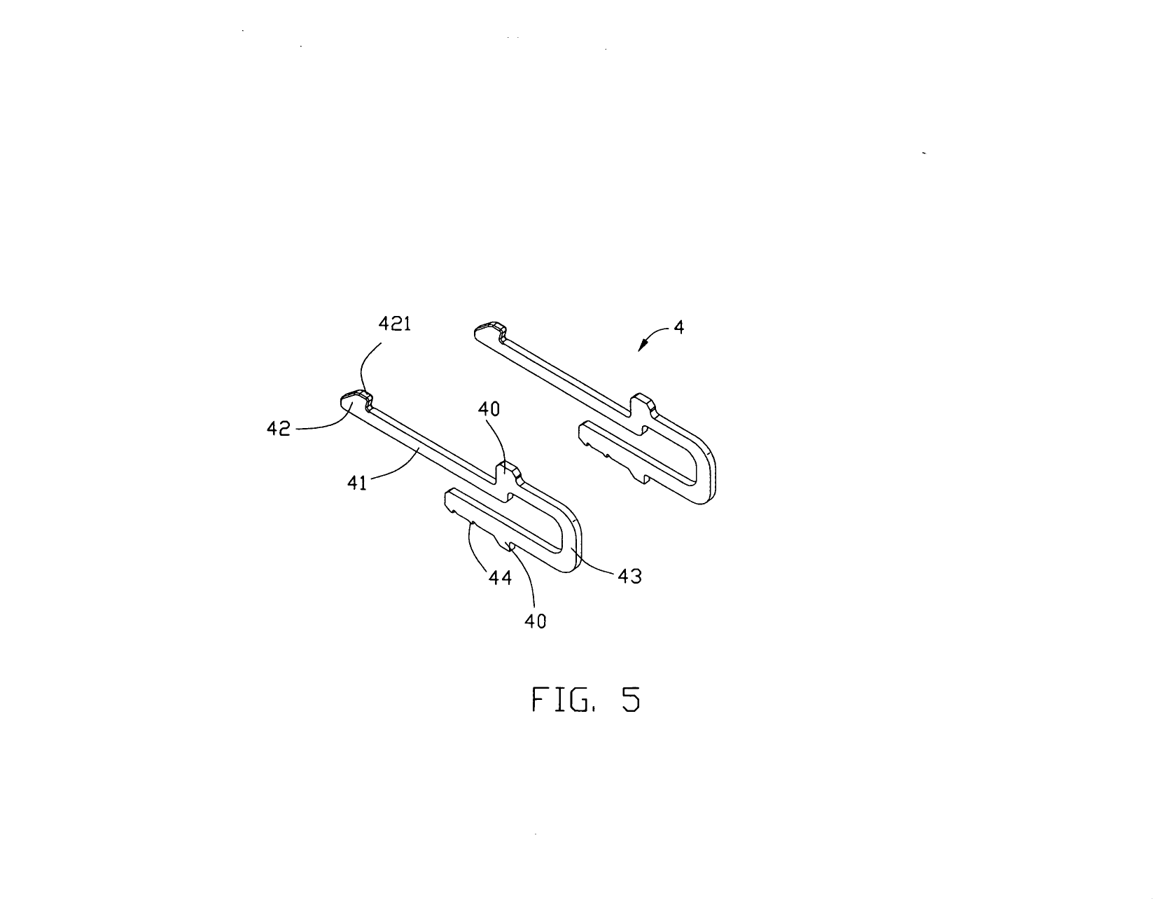

Referring to FIG. 4, the insulative housing 1 defines a plurality of passageways 13 throughout the base portion 10 and the tongue portion for accommodating the terminal 3. Each terminal includes a contact portion 30 exposed to a bottom face of the tongue portion 11 and a leg 31 beyond the base portion 10. The insulative housing 1 further defines a pair of channels 14 beside the outmost the passageways 13 respectively, throughout the base portion 10 for accommodating the locking pieces 4. Jointly referring to FIG. 5, each locking piece 4 is made of metal, and includes a U-shaped portion 43, a cantilever arm 41 extending from one branch of the U-shaped portion and a tail 44 extending from another brach of the U-shaped portion 43. The cantilever arms 41 are inserted into the channels 14, each with a hook 42 disposed in a cutout 121 thereof. The U-shaped portions 43 extend beyond the base portion 10 with tubers 40 at the ends thereof confronting the rear-face of the base portion 10. And the tails 44 with stabs thereon are respectively received in slots 15 under the channels 14 to interlock the locking pieces in the base portion 10. Each free end 421 of a claw structure runs though a nick 212 in the front portion 21 of shell 2 to lock the complement connector, as best shown in FIG. 3.

Referring to FIGS. 2 and 4, the shielding shell 2 is stamped from a metal sheet and closely surrounds the insulative housing 1. The shielding shell 2 includes a front and back portion 21, 22, each portion has a top wall, a bottom wall opposite to the top wall and two opposite sidewalls. The front portion 21 is of a close rectangle structure formed by joining a metal strip end to end with a swallowtail joint at the top wall. The back portion 22 is of an open rectangle structure formed by two pieces of metal, each jointing with the front portion 21 by a connecting portion 23 between the sidewalls 211, 221 thereof. The two top walls 222 of the back portion 22 respectively extend inwards and space from each other. Each of the two sidewalls 221 has a hatch 225 for locking a flange 101 on the sidewall of base portion 10 to fix the shielding shell 2 on the insulative housing. Each of the top walls 222 further defines a curved portion 224 extending downwards and abutting against the front end of the base portion 10 to prevent the shielding shell 2 from moving backwards. The two bottom walls 223 also respectively extend inwards a little and space from each other for being assembled on a PCB (not shown), as best shown in FIG. 4.

Referring to FIG. 1, the shielding shell 2 surrounds the housing for forming said front and back section 102, 103. The pair of connecting portions 23 joining the front and back portion 21, 22 is closely abutting on the base portion. The width W of the connecting portions 23 is predefined according to a largest force, which the complement connector, namely a receptacle, can load when wrong-engagement of the two connectors occurs. A margin force the connecting portion can load is smaller than said largest force of the complement connector. Therefore, the connecting portions damage first, but the receptacle in the system is fine. So, a user replaces the connector easily. The connecting portion 23 includes a middle plate 232 and two opposite ends 231 joining the sidewalls 211, 221 of the front and back portion of the shielding shell 2. The ends 231 also can be formed with an arc structure, so the rupture portion focus on the middle portion 232. In other embodiments, the connecting portion 23 can be formed on the top and bottom walls according simplify of stamping of the shielding shell 2, not in the sidewalls, especially in a connector of a square structure.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. An electrical connector comprising:
an insulative housing having a base potion and a tongue portion projecting forwards from the base portion;
a plurality of terminals arranged on the insulating housing; and
a shielding shell having a front portion surrounding the tongue portion and defining a pair of opposite walls, a back portion surrounding the base potion and defining a pair of corresponding opposite walls, and a pair of connecting portions unitarily connecting the front and back portions at the opposite walls thereof.

2. The electrical connector as described in claim 1, wherein the connecting portion defines two end portions of arc structure at the joints between the front portion and back portion.

3. The electrical connector as described in claim 2, wherein each of the front and back portions is of a rectangular frame with said opposite walls, a top wall and a bottom wall.

4. The electrical connector as described in claim 3, wherein the base portion has a pair of flanges respectively on the opposite walls thereof, and the back portion has a pair of hatch respectively locking the flanges to assemble the shielding shell on the housing.

5. The electrical connector as described in claim 4, wherein the back portion has a curved portion bending from a front fringe of the top wall thereof abutting against the base potion.

6. The electrical connector as described in claim 1, further comprising a pair of locking pieces in the housing to secure engagement with a mating connector.

7. The electrical connector as described in claim 6, wherein each of locking piece comprises a cantilever arm with a claw structure at its free end and projecting the bottom wall of the front portion of shielding shell.

8. The electrical connector as described in claim 7, wherein the base portion has a pair of channels-respectively therethrough and a pair of slots respectively under the channels, each of the locking pieces further comprises a U-shaped portion and a tail extending from one branch of the U-shaped portion to interlock the slot, the cantilever arm is extending from the other branch of the U-shaped portion to pass through the channel.

9. A shielding shell made of a piece of metal sheet and surrounding a connector, comprising:
a front portion with one joint,
a back portion having a left portion and a right portion apart from the left portion, each of left/right portion defining a side wall at opposite positions thereof;
a pair of connecting portions extending outwards from the front portion respectively, one connecting portion connecting the front portion and the left back portion, another connecting portion connecting the front portion and the right back portion.

10. The shielding shell as described in claim 9, wherein the left and right portion space from each other.

11. The shielding shell as described in claim 10, wherein the front and back portion are of rectangular frame respectively.

12. The shielding shell as described in claim 11, wherein the frame of the back portion is larger than that of the front portion.

13. An electrical connector comprising:
an insulative housing having a base potion and a tongue portion projecting forwards from the base portion;
a plurality of terminals arranged on the insulating housing; and
a shielding shell having a front portion surrounding the tongue portion and a back portion surrounding the base potion, and at least one connecting portion being discrete from the shielding shell and extending into the housing; wherein
said connecting portion defines a locking head adjacent to the front portion and extending through the front portion, and an operation portion adjacent to the back portion and operable from an exterior outside of said back portion.
